(19) United States
(12) Patent Application Publication
(10) Pub. No.: US 2004/0155867 A1
(43) Pub. Date: Aug. 12, 2004

(54) Wireless keyboard capable of implementing handwriting function

(76) Inventor: Chang-Fu Lin, Keelung City (TW)

Correspondence Address: BIRCH STEWART KOLASCH & BIRCH, PO BOX 747, FALLS CHURCH, VA, 22040-0747, US

(21) Appl. No.: 10/359,167

(22) Filed: Feb. 6, 2003

(51) Int. Cl. G09G 5/00

(52) U.S. Cl. 345/168

(57) ABSTRACT

A wireless keyboard capable of implementing handwriting function is provided. The wireless keyboard comprises a control circuit. The control circuit comprising a switching matrix circuit; a micro-controller connected to the switching matrix circuit, the micro-controller being used to transform data transmitted from the switching matrix circuit into RS-232 codes; two ultrasonic wave receivers for receiving signals transmitted from a ultrasonic wave generator installed in a pen, and then calculating the coordinate of the pen according to time difference; a microprocessor connected to the two ultrasonic wave receivers, the microprocessor being used to transform the data processed by the ultrasonic wave receivers into UART format; and a bluetooth module connected to the micro-controller and the microprocessor, the bluetooth module being used to transmit the UART format data from the micro-controller or the microprocessor to a computer supported by bluetooth system.

### BACKGROUND OF THE INVENTION

1. Field of the Invention

The present invention relates to a wireless keyboard capable of implementing handwriting function. More particularly, the present invention relates to a wireless keyboard integrated with a handwriting input device.

2. Description of the Prior Art

Heretofore, most of the commercial wireless keyboards are very inconvenient to users who are not familiar with conventional input way through typing keys. Further, users cannot input digital signatures through the typical wireless keyboard, but through a separate handwriting pad, which is typically connected with the computer via a USB interface or the like. For those who type slowly, the handwriting pad can save a great deal of time.

Consequently, there is a need to provide a wireless keyboard incorporated with a handwriting pad thereon for those who type slowly. So far, such wireless keyboard combined with a handwriting pad has not been seen on the market.

### SUMMARY OF THE INVENTION

The main objective of the present invention is to provide a wireless keyboard integrated with a handwriting pad to solve the above-mentioned problem.

Another objective of the present invention is to provide an input device integrating a wireless keyboard with a handwriting pad. The users can select to use the handwriting pad by directly drawing out the handwriting pad from the wireless keyboard to save time.

Still another objective of the present invention is to provide an input device through which a user can use a pen to input data through the keyboard by way of ultrasonic wave, and transmitting the data to the computer from the keyboard in a wireless manner.

According to the claimed invention, a wireless keyboard capable of implementing handwriting function is provided. The wireless keyboard comprises a control circuit. The control circuit comprising:

a switching matrix circuit;

a micro-controller connected to the switching matrix circuit, the micro-controller being used to transform data transmitted from the switching matrix circuit into RS-232 codes;

two ultrasonic wave receivers for receiving signals transmitted from a ultrasonic wave generator installed in a pen, and then calculating the coordinate of the pen according to time difference;

a microprocessor connected to the two ultrasonic wave receivers, the microprocessor being used to transform the data processed by the ultrasonic wave receivers into UART format; and

a bluetooth module connected to the micro-controller and the microprocessor, the bluetooth module being used to transmit the UART format data from the micro-controller or the microprocessor to a computer supported by bluetooth system.

Other objects, advantages and novel features of the invention will become more clearly and readily apparent from the following detailed description when taken in conjunction with the accompanying drawings.

### BRIEF DESCRIPTION OF THE DRAWINGS

FIG. 1 is a typical view according to the first preferred embodiment of the present invention.

FIG. 2 is a circuit block diagram of FIG. 1.

FIG. 3 is a typical view according to the second preferred embodiment of the present invention.

FIG. 4 is a circuit block diagram of FIG. 3.

FIG. 5 is a circuit block diagram according to the third preferred embodiment of the present invention.

### DETAILED DESCRIPTION OF THE PREFERRED EMBODIMENTS

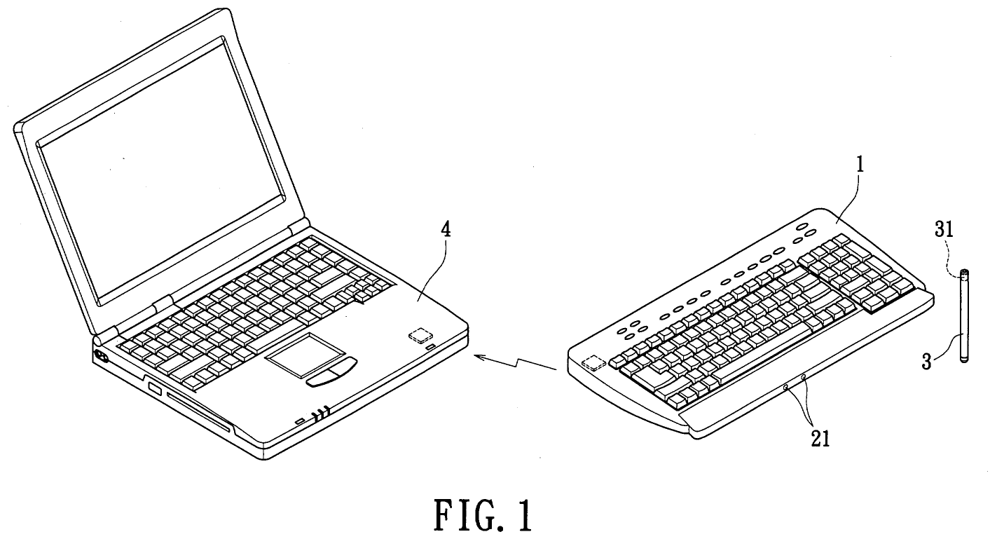

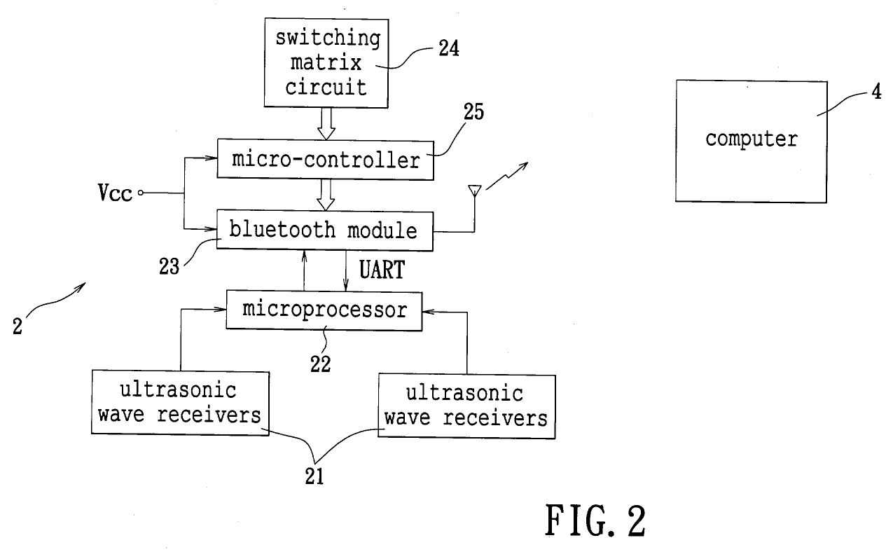

Please refer to FIG. 1 and FIG. 2. The present invention pertains to a user-friendly wireless keyboard integrated with a handwriting pad. The wireless keyboard 1 of this invention comprises a control circuit 2. The control circuit 2 comprises two ultrasonic wave receivers 21, a microprocessor 22, a bluetooth module 23, a switching matrix circuit 24, and a micro-controller 25.

The two ultrasonic wave receivers 21, which are used to receive signals transmitted from the ultrasonic wave generator 31 within the pen 3, are located at the front side of the wireless keyboard 1. The coordinate of the pen 3 can be calculated according to time difference.

The microprocessor 22 is connected with the two ultrasonic wave receivers 21 through a universal asynchronous receiver/transmitter (UART). The microprocessor 22 is used to transformed the data processed by the ultrasonic wave receivers 21 into UART format.

The bluetooth module 23 is connected with the microprocessor 22, and are both biased to same power Vcc. The bluetooth module 23 is used to transform data processed by the microprocessor 22 into the computer 4 through an antenna. The protocols of the bluetooth module 23 include link manager protocol (LMP), link layer control & adaptation protocol (L2CAP), host controller interface (HCI), service discovery protocol (SDP), protocol for RS-232 serial cable emulation (RFCOMM), and so on.

The micro-controller 25 is connected to the switching matrix circuit 24 and the bluetooth module 22. The micro-controller 25 is used to transform the data processed by the switching matrix circuit 24 into RS-232 codes, then transmits the RS-232 codes to the bluetooth module 23. The bluetooth module 23 then transmits the data in RS-232 code format to the computer 4 having bluetooth transmitting system, which supports serial port profile (SPP) and human input device (HID).

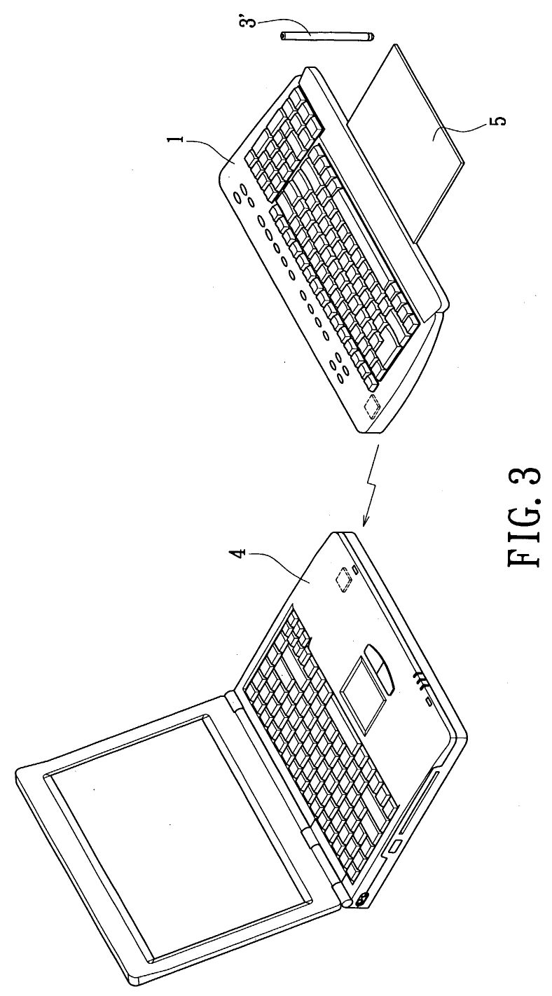

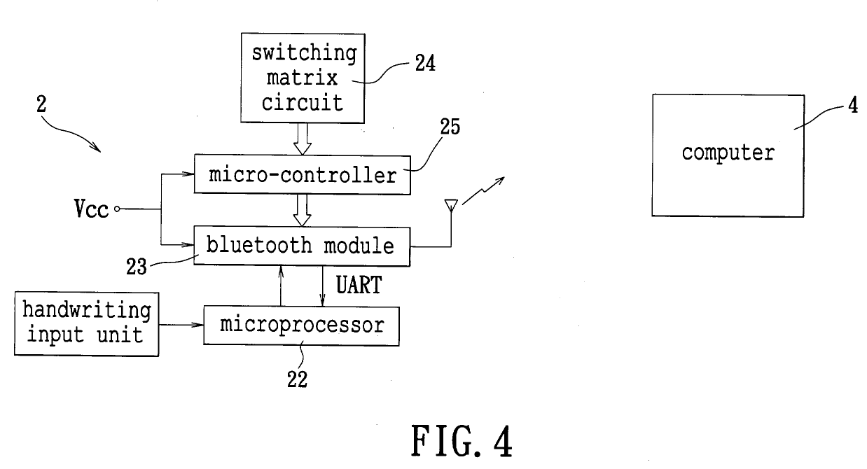

Please refer to FIG. 3 and FIG. 4, which are typical views according to another preferred embodiment of this invention. As shown, the wireless keyboard 1 has a handwriting input unit 5 such as a handwriting pad installed at the front side of the wireless keyboard 1. The handwriting input unit 5 receives the signal from the pen 3′ and calculates the coordinate of the pen 3′. The micro-controller 25 of the control circuit 2 is used to transform the data processed by the switching matrix circuit 24 into HID codes. The microprocessor 22 is used to the data processed by the handwriting input unit 5 into HID codes. The bluetooth module 23 is used to transmit the HID codes processed by the micorprocessor 22 or micro-controller 25 to the computer 4.

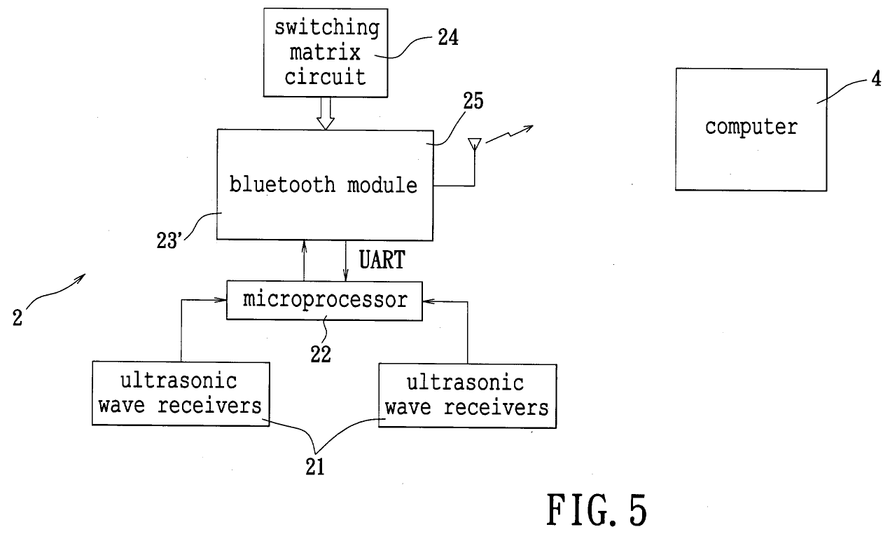

Please refer to FIG. 5. In another case, the micro-controller 25 of the control circuit 2 can be integrated with the bluetooth module 23′, such that the fabrication cost can be reduced.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A wireless keyboard capable of implementing handwriting function, wherein the wireless keyboard comprises a control circuit, the control circuit comprising:
a switching matrix circuit;
a micro-controller connected to the switching matrix circuit for transforming data transmitted from the switching matrix circuit into RS-232 codes;
two ultrasonic wave receivers for receiving signals transmitted from a ultrasonic wave generator installed in a pen, and calculating the coordinate of the pen according to time difference;
a microprocessor connected to the two ultrasonic wave receivers for transforming the data processed by the ultrasonic wave receivers into UART format; and
a bluetooth module connected to the micro-controller and the microprocessor for transmitting the UART format data from the micro-controller or the microprocessor to a computer supported by bluetooth system.

2. The wireless keyboard capable of implementing handwriting function as claimed in claim 1 wherein the ultrasonic wave receivers are installed on a wireless keyboard main body.

3. The wireless keyboard capable of implementing handwriting function as claimed in claim 1 wherein the micro-controller is integrated with the bluetooth module.

4. A wireless keyboard capable of implementing handwriting function, comprising:
a switching matrix circuit;
a micro-controller connected to the switching matrix circuit, the micro-controller being used to transform data transmitted from the switching matrix circuit into HID codes;
a handwriting input unit installed on the wireless keyboard, the handwriting input unit being used to calculating coordinate of a touch pen;
a microprocessor connected to the two ultrasonic wave receivers, the microprocessor being used to transform the data processed by the handwriting input unit into HID codes; and
a bluetooth module connected to the micro-controller and the microprocessor, the bluetooth module being used to transmit the HID code data from the micro-controller- or the microprocessor to a computer supported by bluetooth system.

5. The wireless keyboard capable of implementing handwriting function as claimed in claim 4 wherein the micro-controller is integrated with the bluetooth module.
